(19) United States
(12) Patent Application Publication
(10) Pub. No.: US 2008/0050166 A1
(43) Pub. Date: Feb. 28, 2008

(54) Label Printing System With Replaceable Cleaning Roll

(75) Inventor: Johannes Lenkl, Freising (DE)

Correspondence Address: CHRISTIE, PARKER & HALE, LLP, PO BOX 7068, PASADENA, CA, 91109-7068, US

(73) Assignee: AVERY DENNISON CORPORATION, Pasadena, CA (US)

(21) Appl. No.: 11/665,780

(22) PCT Filed: Oct. 17, 2005
(86) PCT No.: PCT/EP05/11148

§ 371 Date: Sep. 27, 2007

(30) Foreign Application Priority Data
Oct. 15, 2004 (DE) 10 2004 050 379.6

(51) Int. Cl. B41J 29/17

(52) U.S. Cl. 400/701

(57) ABSTRACT

The invention relates to a system for printing labels, especially labels of textile products, with at least one printing unit that includes at least one print head, one non-motorized printing roller, whereof the print head and/or the printing roller are mutually movable in a reversible manner, and at least one cleaning unit. Furthermore it is given that the cleaning unit is constituted by a non-motorized cleaning roller which can be replaced with the printing roller.

### CROSS-REFERENCE TO RELATED APPLICATION(S)

This application is a National Phase Patent Application of International Application Number PCT/EP2005/011148, filed on Oct. 17, 2005, which claims priority of German Patent Application Number 10 2004 050 379.6, filed on Oct. 15, 2004.

### BACKGROUND OF THE INVENTION

1. Field of the Invention

The present invention concerns a system for the imprinting of labels, especially textile labels, as well as a procedure to clean such a system.

2. Description of Related Art

A general problem that occurs with printers is that the print head gets dirty over the course of time. This applies especially to those printers that work with heat and/or pressure. Such a printer is used for example in imprinting of labels, especially textile labels. During imprinting, single particles fall from the label. In the case of textile labels, parts of the fibre of the label attach to the print head. Due to the heat and/or pressure used during imprinting, the attachments harden. The attachments have to be removed from time to time to maintain an optimum print result.

Conventionally, removal of the attachments is made by using a sharp object to mechanically remove the dirt from the print head. By such a removal, not only the print head can be damaged, but also the result of the cleaning can be unsatisfactory, as not all particles can be securely removed.

Alternatively, label bands are provided with an original material that has an abrasive coating to clean the print head mechanically. Such label bands are expensive in their production and may result in an unsatisfactory cleaning due to the exclusively grinding processing step. Furthermore, use of label bands in a cleaning process can only be made when a new label band is inserted. If a printer has a longer downtime it may be impossible for the abrasive coating to remove particles that have become strongly attached.

Another well known method is to completely dismount the print head from the printer to clean it. Dismounting the print head is time consuming and therefore expensive. Furthermore, the print head must be adjusted after reassembly in order to receive an optimal print result.

### SUMMARY OF THE INVENTION

The present invention provides a system for the imprinting of labels, especially textile labels, as well as a procedure for the cleaning of such a system, which allows the cleaning procedure to be achieved in a simple and fast way. More particularly, the label printing system includes at least one printing unit that includes at least one print head, one non-motorized printing roller, and at least one cleaning unit. The at least one print head and/or the printing roller is mutually movable in a reversible manner. The at least one cleaning unit includes a non-motorized cleaning roller that is replaceable with the printing roller.

The present invention further provides a method for cleaning a label printing system. The label printing system has a printing roller, a cleaning roller, and a print head. The method includes replacing the printer roller with the cleaning roller, lowering the print head onto the cleaning roller, turning the cleaning roller, lifting the print head, and replacing the cleaning roller with the printing roller.

Due to the provision of a replaceable cleaning roll, which can be replaced with the printing roll, the cleaning procedure can be quickly conducted, without requiring the print head to be dismounted or the application of special label bands. Furthermore, damage to the print head is avoided because no sharp edged cleaning tools are used. Such a cleaning roll can be designed so that cleaning is optimised, i.e., the cleaning roll can absorb a cleaning agent, hold the cleaning agent, and dispense the cleaning agent during the cleaning process.

Principally, it is imaginable to use a cleaning roll which differs in its axial length and/or its diameter and/or its connecting dimensions from the printing roll, especially for the storage of the roll in the printing system. However, to be able to quickly and without great preparations conduct the cleaning procedure, it is beneficial if the cleaning roll corresponds at least approximately with its width, i.e., axial length and/or its diameter and/or its connection diameters. With corresponding dimensions, the print roll can be simply taken out of the print system or the printer after loosening an axial securing device, and afterwards the cleaning roll can be inserted without further preparation, such that the cleaning process can take place directly afterwards.

For best results, the cleaning surface should correspond to the maximum print width.

As already mentioned before, the cleaning roll can be separately designed for its special task. The cleaning roll can feature an abrasive acting surface, which removes the particles attached to the print head by mechanical execution. The abrasive character can be effected by different methods. The surface of the cleaning roll can consist of some grinding tools, which stand upwards on top of the surface of the cleaning roll. It can also be designed so that the abrasive character of the surface of the cleaning roll includes areas with different grinding effects, and these different abrasive acting areas can be coordinated. For example, one of the areas of the surface of the cleaning roll can be designed to have a coarser grinding effect and another area has a finer grinding effect.

The cleaning roll can be provided so that a cleaning agent, especially a liquid cleaning agent, can be applied and soaked into the cleaning roll. It is advantageous if the cleaning roll is able to store the cleaning agent and to dispense it continually or discontinuously. The cleaning roll may dispense discontinuously in consequence of the pressure which is applied on the cleaning roll by the print head. To achieve the aforementioned result, it is beneficial if at least the surface of the cleaning roll is formed of an expanded or porous, preferably elastic plastic compound or foam plastic mixture with corresponding characteristics.

In principle, it could be sufficient to only insert the cleaning roll beneath the print head and to move the print head and/or the cleaning roll against each other. The latter would be especially possible if a cleaning detergent is applied to the cleaning roll and the cleaning detergent is able to clean the print head by pure immersion. But to further optimize the cleaning result, the cleaning rolls can be turned during the cleaning process, to bring different areas of the cleaning roll in contact with the print head. That is, the cleaning rolls may be turned to bring different areas of the cleaning roll with an abrasive effect and/or different areas of the cleaning roll which are soaked with the cleaning agent in contact with the print head. It is in principle possible that a powered motor is designed for the rotation of the cleaning roll, which can be, for example, part of the cleaning roll. A more economical solution is provided when the device allows for the manual rotation of the cleaning roll, which could be, for example, a knurl or a knurled knob.

As explained above, one can replace the printing roller with the cleaning roller for cleaning purposes. To avoid damage to the cleaning roller during periods of non-usage, the cleaning roller can be stored during periods of non-usage in a container in the printing unit. Concerning this issue, it's better when the container includes a tank for cleaning material or cleaning liquid which wets the cleaning roller in the container continuously with cleaning liquid. Thus, one can start immediately the cleaning treatment after removing the cleaning roller out of the container and exchanging the printing roller with the cleaning roller. The tank may be constructed with a foam covering inside the container. The foam coating may have such a form that the cleaning roller is entirely and closely covered by the foam covering. That means that wetting of the cleaning roller with cleaning materials or liquids is possible, and the cleaning roller is fixed up in its position in the container. Such cleaning materials often carry hidden substances. Therefore, it's always better when the container can be closed hermetically.

As explained earlier, the print head and/or the printing roller or the cleaning roller may be constructed in such a manner that the print head, printing roller, and/or cleaning roller include the possibility of moving in a reversible manner. A very simple and therefore economical solution can be achieved when only the print head can be moved or lowered down to the cleaning roller in a reversible manner. To carry out a cleaning operation, the print head may be lowered down on the cleaning roller after the printing roller is replaced with the cleaning roller, and by means of manually turning the cleaning roller, cleaning material is applied on the surface of the print head and/or by means of the abrasive effects of the surface of the cleaning roller towards the print head. There is also provided the option that, during the cleaning operation, the print head lies on the cleaning roller with the same pressure as the pressure between the print head and the printing roller during the printing operation. However, the pressure may be higher or lower. Generally, the cleaning operation can be carried out by only one operator and without a special controlling appliance of the printer. In this operation the print head may be lowered by pushing the print button. Thus, a printing operation is simulated during cleaning. Nevertheless, this may result in additional damage to the print head, because the print head lies on the cleaning roller by being heated and having a high pressure. In addition, the operator may be injured, too. To avoid this, it is better to have a controlling appliance with at least one program memory where at least one cleaning program is stored. Such a cleaning program may control the lowering of the print head and/or the contact pressure of the print head lying on the cleaning roller.

To protect the operator from being injured during the mutual approach of print head and/or cleaning roller, the cleaning program is initiated through a separate button at the printer whereby the print head lies on the cleaning roller as long as the related button is pushed down. When the operator releases the button, the print head and/or the cleaning roller move in opposite directions. For this purpose it will be better when the button is located a sufficient distance from the print head and the cleaning roller that the operator has to use both of his hands in order to turn the cleaning roller and to push the button.

### BRIEF DESCRIPTION OF THE DRAWINGS

Additional advantageous designs and a sample application will be explained below by means of appended drawings. For this purpose it is important to mention that some words used during the explanation like “left”, “right”, “below”, and “above” are related with the drawings with normally readable shape descriptions and relation signs, wherein:

FIG. 1 is a lateral view of an invention system with a printing unit bearing a print head and a printing roller;

FIG. 2 is a partial perspective of the printing unit showed in FIG. 1 with integrated cleaning roller and nearby located printing roller whereby the scale is increased; and

FIG. 3 is a frontal perspective of the invention system with an enlarged controlling area of the system.

### DETAILED DESCRIPTION

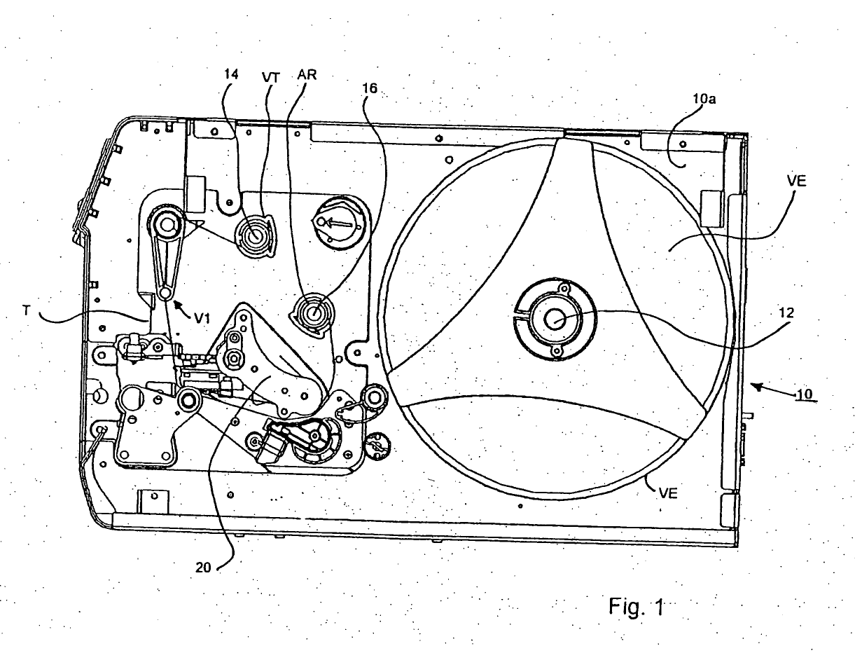

According to one embodiment of the invention, a label printing system (especially for printing of labels for textile products) includes a body frame 10. Only the vertical sidewall 10a of the body frame is shown in FIG. 1. On the vertical sidewall 10a are first, second, and third bearing arrangements 12, 14, 16; a printing unit 20; and a separator (not shown). Alternatively, the separator is designed and organized separately from the body frame 10 as an independent unit.

The first bearing arrangement 12 is a reversible support for the reserve roll VE for the label tape which consists of rows of non-printed labels. The second bearing arrangement 14 is a reversible support for the reserve roll VT of the thermal transfer ribbon T. The third bearing arrangement 16 is a reversible support for the receiving roll AR, which is constructed to receive the used thermal transfer ribbon T. The bearing arrangements 12, 14, 16 may be formed with one reversible roller each, and the rolls VE, VT, AR may slide on the roller and be fixed on the roller axially if necessary. The location of the rollers with respect to the vertical sidewall 10a is such that the middle axis of each roll VE, VT, AR extends horizontally and is perpendicular to the vertical sidewall 10a.

The label tape is separated from the reserve roll VE and directed to the printing unit 20 through a label feeding apparatus. The label feeding apparatus can be built through two rollers, which include slots that feed to each other. At least one of the pair of rollers may be motor-driven. In this regard, the pair of rollers can be located between the printing unit 20 and the reserve roll VE and/or in the printing unit 20. Additional roller pairs may be placed if necessary, and one of these pairs can be located behind the printing unit 20 in the feeding direction of the label tape. Further, the reserve roll VE may be motor-driven itself.

A thermal transfer ribbon feeding apparatus for the thermal transfer ribbon T may be constructed similar to the label feeding apparatus. In this case, the receiving roll AR is motor-driven. Both feeding apparatuses are capable of feeding the label tape or the thermal transfer ribbon T continuously or without continuity (i.e., step by step) to the printing unit 20. A controlling appliance coordinates control of the feeding movements of the label tape and the thermal transfer ribbon T. The controlling appliance (not shown) has controlling contact to the label feeding unit and the thermal transfer ribbon feeding unit. The label tape E (not shown) is directed to the printing unit 20 over a directing roll by means of the label feeding apparatus after it is removed from the reserve roll VE.

As depicted in FIG. 1, the thermal transfer ribbon T is directed to the printing unit 20 above the feeding route of the label tape towards the feeding apparatus. The feeding apparatus is shown in FIG. 1 with the arrow marked V1. After the color of a printing field of the thermal transfer ribbon T is exhausted, the tape is directed to the receiving roll AR, which is supported by the bearing arrangement 16.

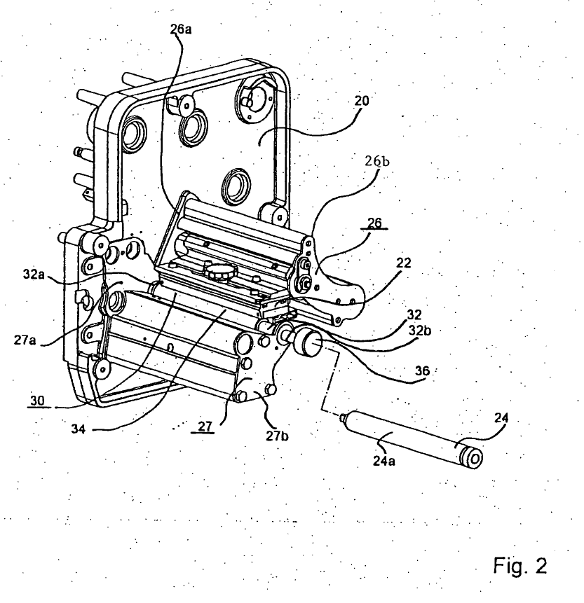

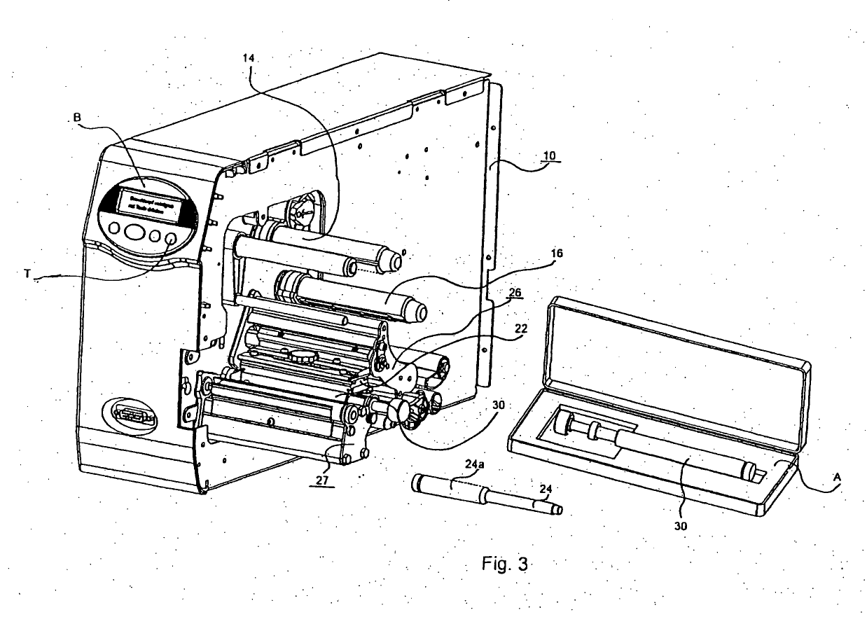

In FIG. 2 and FIG. 3 the structure of printing unit 20 is depicted. The main components of the printing unit 20 are the thermal transfer head 22, the printing roller 24 which works together with the thermal transfer head 22, and the first and second bearing arrangements 26, 27. The first bearing arrangement 26 consists of two bearing sheets 26a and 26b, which are located approximately parallel to each other at a certain distance apart, and which are also parallel to the feeding and expulsion directions of the label tape. The thermal transfer head 22 is located between the bearing sheets 26a and 26b. The thermal transfer head 22 is placed directly or by means of a support towards the bearing sheets 26a and 26b and mainly diagonal to the feeding direction of the label route. The support can be used for the thermal transfer head 22, but is not shown detailed in FIG. 2 and FIG. 3. The second bearing arrangement 27 also consists of two bearing sheets 27a and 27b, which are located approximately parallel or at a certain distance from each other, and which are also parallel to the feeding and expulsion directions of the label tape route. The printing roller 24 is located between the bearing sheets 27a and 27b. The printing roller 24 is placed towards the bearing sheets 27a and 27b and mainly diagonal to the feeding direction of the label route. The printing roller 24 is secured axially. This axial security can be removed in order to replace the printing roller 24 with the cleaning roller 30. The axial security may consist of an axle nut, a clamp, or another suitable device.

As depicted in FIG. 2 and FIG. 3, different types of printing rollers 24 may be used. The main difference between the printing rollers of FIG. 2 and FIG. 3 is that the covering area 24a of the printing roller depicted in FIG. 2, which defines the real printing area of the printing roller 24, includes a larger axial length than the covering area of the printing roller depicted in FIG. 3.

As especially observable from FIG. 2 and FIG. 3, the printing roller 24 may be replaced with the cleaning roller 30. The cleaning roller 30 has at least approximately the same axial length, the same diameter, and/or (especially for purposes of storing the cleaning roller in the printing system) the same connection dimensions as the printing roller 24. Thus, the cleaning roller 30 may be used instead of the printing roller 24 in the bearing arrangement 27. The carrying axle 32 of the cleaning roller 30 has a mainly round-cylindrical shape and an abrasive surface covering, which is able to hold a cleaning material, preferably a cleaning liquid. The surface covering can be fixed tightly to the axle 32 in an axial manner. The carrying axle 32 includes bearing arrangements at its left front end 32a and nearby its right front end 32b, which are not depicted in detail. Due to these bearing arrangements, the cleaning roller 30 can be reversibly placed in the bearing arrangement 27 instead of the printing roller 24. The carrying axle 32 includes a flywheel 36 at its right front end 32b, which is secured against turning. The flywheel's diameter is bigger than the diameter of the carrying axle 32 together with the surface covering 34. The flywheel 36 permits the cleaning roller 30 to be turned manually in both directions in a reversible manner.

As explained above, the surface covering 34 is designed to have an abrasive effect. This may be achieved by locating stony pieces (not shown) into the surface covering 34. In addition, the surface covering 34 is capable of holding a cleaning material which, preferably, consists of a cleaning liquid. The cleaning material loosens attachments, which are formed by the heat and the pressure during normal printing operation, such that the attachments can be easily removed from the print head 22 by the abrasive surface 34 of cleaning roller 30.

In addition, the label printing system includes a controlling appliance (not shown), which has a program memory capable of storing at least one cleaning program. The cleaning program controls a position of the thermal transfer head 22 by reversibly lowering the thermal transfer head 22 from its stable position to a position in contact with the cleaning roller 30 during a cleaning operation. The cleaning program is also able to control other functions of the printing system or the printer that are necessary for the cleaning operation. The cleaning program is initiated by the button T on the operator's keyboard of the label printing system (see FIG. 3). To protect the operator from injuries that can result from the lowered print head 22 or from its heat during cleaning operations, the cleaning program may require that button T be pushed down during the whole cleaning operation.

The progression of the cleaning operation is as follows:

First, the printing system is stopped and opened. The body frame 10 of the printer, which is shown in part only, may be equipped with one or more body switches (not shown) that ensure that the printer stands entirely still when it is opened. When the printer is opened, the print head and the feeding appliances for the individual tapes are driven into their initial position. Afterwards, the rest of the label tape (if available) and the rest of the thermal transfer tape T may be removed from the printer. Afterwards or immediately before or simultaneously, the print head 22 is moved to its initial position or to its waiting position where the head is separated from the printing roller 24. Then the axial security of the printing roller 24 is loosened and the roller is removed from the bearing arrangement 27.

Next, the cleaning roller 30, which has been wetted with cleaning material in its container A, is removed from its container A and located in the bearing arrangement 27 in place of the printing roller 24. The cleaning roller is fixed axially in the bearing arrangement 27.

Afterwards, the button T is pushed down, which results in the thermal transfer head 22 being lowered down on to the cleaning roller 30. Due to the activation of the flywheel 36, the cleaning roller 30 begins to turn according to the cleaning needs. The cleaning process continues according to the operator's estimation or under control of the program until the print head 22 is cleaned.

Then, the button T is released and print head 22 drives back to its waiting position. Next, the cleaning roller 30 is removed from the bearing arrangement and swapped out for the desired printing roller 24, which is placed and secured axially. The cleaning roller 30 is then replaced in the container A and the container is locked.

Afterwards, the printer body frame 10 is closed and, after the placement of the label tape and the thermal transfer tape T, the printing operation can be continued.

1.-17. (canceled)

18. A label printing system comprising:
at least one printing unit that includes at least one print head, one non-motorized printing roller, and at least one cleaning unit, the at least one print head and/or the printing roller being mutually movable in a reversible manner, and the at least one cleaning unit including a non-motorized cleaning roller which is replaceable with the printing roller.

19. The label printing system according to claim 18, wherein an axial length of the cleaning roller is approximately equal to an axial length of the printing roller and a diameter of the cleaning roller is approximately equal to a diameter of the printing roller.

20. The label printing system according to claim 18, wherein the cleaning roller includes at least a partially abrasive surface.

21. The label printing system according to claim 20, wherein the surface of the cleaning roller includes stony pieces.

22. The label Printing system according to claim 18, wherein a surface of the cleaning roller is adapted to hold and to deliver a cleaning material.

23. The label printing system according to claim 18, wherein a surface of the cleaning roller includes a porous or a foam plastic mixture.

24. The label printing system according to claim 18, wherein the cleaning roller includes a flywheel for manually turning the cleaning roller.

25. The label printing system according to claim 18, wherein the cleaning roller is storable in a container during periods of non-usage in the printing unit.

26. The label printing system according to claim 25, wherein the container includes a tank for holding cleaning liquid, the tank wetting a cleaning roller placed in the container with a cleaning material.

27. The label printing system according to claim 26, wherein the tank includes a foam filling inside of the container.

28. The label printing system according to claim 18, wherein the at least one print head is lowerable down onto the cleaning roller.

29. The label printing system according to claim 18, further comprising:
a controlling appliance with at least one program memory containing at least one cleaning program.

30. The label printing system according to claim 18, further comprising:
a button for initiating a cleaning operation, the button being pushed down for lowering the at least one print head at the beginning of the cleaning operation and during the cleaning operation.

31. A method for cleaning a label printing system, the label printing system having a printing roller, a cleaning roller, and a print head, the method comprising:
replacing the printing roller with the cleaning roller;
lowering the print head onto the cleaning roller;
turning the cleaning roller;
lifting the print head; and
replacing the cleaning roller with the printing roller.

32. The method according to claim 31, the method further comprising:
lowering the print head onto the cleaning roller by pushing a button down continuously.

33. The method according to claim 31, further comprising:
wetting the cleaning roller with a cleaning material prior to replacing the printing roller with the cleaning roller.

34. The method according to claim 31, further comprising:
storing the cleaning roller in a container during periods of non-usage.
